(19) United States
(12) Patent Application Publication
(10) Pub. No.: US 2009/0097808 A1
(43) Pub. Date: Apr. 16, 2009

(54) Fluid waveguide and uses thereof

(75) Inventors: Daniel B. Wolfe, Livingston, NJ (US); Kateri E. Paul, Everett, MA (US); Dmitri V. Vezenov, Center Valley, PA (US); Brian T. Mayers, Somerville, MA (US); Richard S. Conroy, Cheverly, MD (US); Piotr Garstecki, Brwinow (PL); Michael A. Fischbach, Boston, MA (US); Valentine I. Vullev, Riverside, CA (US); Kam Yan Tang, Cambridge, MA (US); Mara G. Prentiss, Belmont, MA (US); George M. Whitesides, Newton, MA (US)

Correspondence Address: WOLF GREENFIELD & SACKS, P.C., 600 ATLANTIC AVENUE, BOSTON, MA, 02210-2206, US

(73) Assignee: President and Fellows of Harvard College, Cambridge, MA (US)

(21) Appl. No.: 11/658,339

(22) PCT Filed: Aug. 1, 2005
(86) PCT No.: PCT/US2005/027535

§ 371 Date: Dec. 15, 2008

Related U.S. Application Data
(60) Provisional application No. 60/592,920, filed on Jul. 30, 2004.
(60) Provisional application No. 60/625,861, filed on Nov. 8, 2004.

(51) Int. Cl. G02B 6/032

(52) U.S. Cl. 385/125

(57) ABSTRACT

The invention relates to methods and apparatuses for guiding and emitting electromagnetic radiation from a fluid waveguide. Various methods for changing optical properties (e.g., refractive index, absorption, and fluorescence) and/or physical properties (e.g., magnetic susceptibility, electrical conductivity, and temperature) of either the waveguide core or the cladding, or both, are provided herein. In one embodiment, electromagnetic radiation is guided and/or emitted at multiple distinct wavelengths, including emission in the form of an essentially continuous band, in some cases covering at least 150 nanometers. In another embodiment, methods for splitting a waveguide core and/or the joining of at least two waveguide cores in a waveguide are provided. In yet another embodiment, the invention includes the use of thermal gradients to generate a waveguide and/or to change the properties of waveguides. Embodiments of the waveguides may be used for optical detection or spectroscopic analysis.

### FIELD OF THE INVENTION

This invention relates to methods and apparatus for guiding electromagnetic radiation with a waveguide and, more specifically, to methods and apparatus for guiding and/or emitting electromagnetic radiation with a waveguide having a fluid core.

### BACKGROUND OF THE INVENTION

Waveguides are used to deliver electromagnetic radiation, such as signals, across distances. Optical fibers are one example of known waveguides. A typical optical fiber is a long, thin strand of glass including a glass core where the light travels, a cladding surrounding the core of refractive index lower than that of the core that tends to confine the light within the core, optionally additional cladding layers, and optionally an outer coating that protects the fiber from damage and moisture. The light in an optical fiber can be made to travel through the core with high spatial confinement and low loss via internal reflection resulting from the refractive index difference between the core and the cladding.

Optical waveguides that include a liquid core and/or cladding are known. U.S. Pat. No. 5,194,915 to Gilby describes a dual layer liquid flow stream wherein a sample liquid is positioned within a central portion of the stream, while a sheath liquid, of lower refractive index, is provided which surrounds the sample liquid. Under conditions of laminar flow, a smooth boundary exists between the sample and sheath liquids through the region of interest. A narrow beam of light is directed along the axis of the flowing stream, so that it enters the sample liquid and is contained within it by total internal reflection at the boundary between the sample and sheath liquid. The flowing streams therefore act as an optical waveguide for a beam of light which excites fluorescence in the sample.

Waveguides having a liquid core and a rigid solid cladding are also known, as described in O. J. A. Schueller, X.-M. Zhao, G. M. Whitesides, S. P. Smith, M. Prentiss, Adv. Matter, 11, 37 (1999).

Optical detection and spectroscopic analysis are important in many systems in which two or more analyses are done together, e.g. in micrototal analysis systems (μTAS). Typical methods used for delivery of light to microchannels rely on the coupling of external sources of light to microfluidic devices and typically use optical fibers. The use of an optical fiber requires alignment of the fiber with the microfluidic system being examined, the need for multiple sources of light (in the case of CW lasers), and the limitations on design imposed by restrictions on the size and positions of the microchannels.

While the above-described devices represent significant advances in optical waveguides, improvements are needed.

### SUMMARY OF THE INVENTION

The present invention involves waveguides having fluid cores and, in many cases, fluid claddings. Embodiments of the invention may be used in microfluidic environments, where laminar flow of fluids can be readily established, facilitating such waveguides.

One aspect of the invention involves guiding electromagnetic radiation in waveguides including fluid cores and claddings. In one embodiment, a method involves guiding electromagnetic radiation in a waveguide core comprising a fluid, the waveguide core being adjacent the fluid cladding. The method further comprises establishing an internally-reflective electromagnetic radiation pathway within the core, and delivering electromagnetic radiation from the core to affect or analyze a chemical, biochemical, or biological reaction that is outside the core, or to affect or analyze a chemical, biochemical, or biological species that is outside the core.

In another aspect, a method involves guiding and emitting electromagnetic radiation from a fluid waveguide that comprises at least one emissive species. The electromagnetic radiation that is emitted may be in an essentially continuous band covering at least 150 nanometers.

According to another embodiment of the invention, an apparatus comprises a longitudinal series of channels, each channel adapted for supporting a fluid waveguide core and/or an adjacent fluid cladding. The series of channels includes at least two separate and longitudinally substantially aligned channels, each channel being connectable to a source of fluid to form the waveguide core and/or cladding.

In a further aspect of the invention, an apparatus comprises an array of at least two channels or compartments that can be closely positioned relative to each other, e.g. laterally adjacent, each channel adapted for supporting a fluid waveguide core and/or an adjacent fluid cladding. The apparatus includes an adapter for combining the emissions of at least two of the waveguides, optionally combining the emission of each waveguide. One or more channels are connectable to a source of fluid to form a waveguide core and/or cladding.

According to another embodiment of the invention, a method involves guiding electromagnetic radiation in a waveguide core comprising a fluid, the waveguide core being adjacent a fluid cladding, and the electromagnetic radiation carrying a time-varying signal. The method further comprises establishing an internally-reflective electromagnetic radiation pathway within the core, and delivering electromagnetic radiation from the core to a device constructed and arranged to decode the time-varying signal carried by the electromagnetic radiation.

In a further embodiment of the invention, a method involves providing a fluid waveguide core able to guide electromagnetic radiation with assistance of an adjacent fluid cladding. Electromagnetic radiation is guided in the core, and the physical orientation of the core relative to the cladding is changed. After the physical orientation of the core relative to the cladding is changed, electromagnetic radiation is guided in the core as well.

In yet another embodiment of the invention, a method comprises providing electromagnetic radiation from an arrangement including a fluid core and a fluid cladding, the arrangement being supported within a flexible channel.

According to another embodiment of the invention, a method involves guiding electromagnetic radiation in a waveguide core including a fluid, the waveguide core being adjacent a fluid cladding. The method also includes establishing an internally-reflective electromagnetic radiation pathway within the core, and, while an internally-reflective electromagnetic radiation pathway exists within the core, changing the composition of the core and/or the cladding.

In another aspect, the invention involves an apparatus. In one embodiment, an apparatus includes a channel for supporting a fluid waveguide core and an adjacent cladding. The apparatus also includes a core fluid inlet for receiving a fluid that forms the core, a cladding fluid inlet for receiving a fluid that forms the cladding, and an electromagnetic radiation source constructed and arranged to irradiate the core from a non-axial direction relative to the axis of the channel.

According to a further embodiment of the invention, an apparatus includes a channel for supporting a fluid waveguide core and an adjacent cladding. The apparatus also includes a core fluid inlet for receiving a fluid that forms the core, a cladding fluid inlet for receiving a fluid that forms the cladding, and an electromagnetic radiation sensor for collecting at least a portion of the electromagnetic radiation that exits the core in the direction of the channel axis.

According to yet another embodiment of the invention, an apparatus includes a flexible channel for supporting a fluid waveguide core and an adjacent fluid cladding, a core fluid inlet for receiving a fluid that forms the core, and a cladding fluid inlet for receiving a fluid that forms the cladding.

In yet another embodiment of the invention, an optical waveguide includes a core, a cladding, and a channel for supporting the core and the cladding, wherein the core is in contact with the cladding and walls of the channel simultaneously.

In another embodiment of the invention, a method for guiding electromagnetic radiation in a waveguide comprises forming at least first, second, and third fluid waveguide cores adjacent a fluid cladding, the first, second, and third cores able to guide electromagnetic radiation and the second and third cores joining the first core at a splitting junction, and guiding electromagnetic radiation within each of the first, second, and third cores.

In another embodiment of the invention, a method for guiding electromagnetic radiation in a waveguide comprises guiding electromagnetic radiation in a first fluid core of the waveguide, the first fluid core being adjacent to a fluid cladding, guiding electromagnetic radiation in a second fluid core of the waveguide, the second fluid core being adjacent to a fluid cladding, and removing an optical interface between the first and second cores.

In another embodiment of the invention, a method for propagating electromagnetic radiation in a waveguide comprises flowing a first fluid from an upstream location toward a downstream location within a channel, the first fluid defining a waveguide core, flowing a second fluid adjacent to the first fluid from the upstream location toward the downstream location within the channel, the second fluid defining a fluid cladding, wherein the first and second fluids can be the same or different, establishing an internally-reflective electromagnetic radiation pathway within the waveguide core, and while maintaining an internally-reflective electromagnetic radiation pathway within the waveguide core, causing at least a portion of the first and/or second fluids, passing the downstream location of the channel, to be re-introduced into the channel and to flow again from the upstream location toward the downstream location within the channel.

In another embodiment of the invention, an apparatus is provided. The apparatus comprises a channel for supporting at least one fluid waveguide core and an adjacent fluid cladding, the channel having an axial direction and comprising a core fluid inlet for receiving a fluid that forms a core, a cladding fluid inlet for receiving a fluid that forms a cladding, and at least one fluid outlet, wherein the apparatus is constructed and arranged to enable splitting of the waveguide core and/or joining of two waveguide cores, and an electromagnetic radiation source constructed and arranged to irradiate the waveguide core in the channel in the axial direction from an outlet towards an inlet.

In another embodiment of the invention, a method for guiding electromagnetic radiation in a waveguide comprises providing a first fluid having a first temperature in a microfluidic channel, the first fluid defining a waveguide core, providing a second fluid having a second temperature in the microfluidic channel, the second fluid defining a fluid cladding, wherein the first and second fluids can be compositionally identical or different, and wherein the first and second temperatures are different, and guiding electromagnetic radiation in the waveguide core.

In another embodiment of the invention, a method for guiding electromagnetic radiation in a waveguide comprises providing a fluid in a microfluidic channel having an axial direction, establishing a thermal gradient in the fluid, thereby forming a waveguide core and a waveguide cladding in the fluid, and guiding electromagnetic radiation in the waveguide core, under conditions in which the fluid would not define a core and a cladding suitable for guiding electromagnetic radiation in the absence of the thermal gradient.

In another embodiment of the invention, an apparatus comprises a first fluid having a first temperature in a microfluidic channel, the first fluid defining a waveguide core, and a second fluid having a second temperature in the microfluidic channel, the second fluid defining a fluid cladding, wherein the first and second fluids can be compositionally identical or different, and wherein the first and second temperatures are different.

In another embodiment of the invention, an apparatus comprises a fluid in a microfluidic channel having an axial direction, and a thermal gradient in the fluid, wherein the thermal gradient forms a waveguide core and a waveguide cladding in the fluid, under conditions in which the fluid would not define a core and a cladding suitable for guiding electromagnetic radiation in the absence of the thermal gradient.

Described above are various methods provided in accordance with the invention, each of which involves a waveguide including at least one fluid component. In connection with each method, the invention also provides a corresponding composition and/or article including a channel, which can be a microfluidic channel, comprising a core and cladding as described above and, in connection with each such description, peripheral components recited in the method.

The subject matter of this application may involve, in some cases, interrelated products, alternative solutions to a particular problem, and/or a plurality of different uses of a single system or article.

### BRIEF DESCRIPTION OF THE DRAWINGS

Other advantages, features, and uses of the invention will become apparent from the following detailed description of non-limiting embodiments of the invention when considered in conjunction with the accompanying drawings, which are schematic and which are not intended to be drawn to scale. In the figures, each identical or nearly identical component that is illustrated in various figures typically is represented by a single numeral. For purposes of clarity, not every component is labeled in every figure, nor is every component of each embodiment of the invention shown where illustration is not necessary to allow those of ordinary skill in the art to understand the invention. In cases where the present specification and a document incorporated by reference include conflicting disclosure, the present specification shall control.

FIG. 1 illustrates one embodiment of an optical waveguide system;

FIG. 2A shows a cross-sectional view taken along line IIA-IIA of FIG. 1 illustrating one embodiment of a waveguide core physically oriented relative to a cladding;

FIGS. 2B-2C illustrate examples of a waveguide core having a physical orientation relative to the cladding that is different than FIG. 2A;

FIGS. 3A-3C illustrate examples of changes to the physical orientation of core relative to cladding that may be produced through various methods;

FIG. 4A illustrates one embodiment of a microfluidic switch apparatus;

FIGS. 4B-4C show a waveguide core being switched from one branch of a channel to another branch of a channel;

FIG. 5 illustrates one embodiment of an evanescent coupler apparatus that includes two fluid/fluid waveguides which share an inner cladding;

FIG. 6 is a graph showing the light intensity ratio of the light emitted from a coupled waveguide to the light emitted from an illuminated waveguide;

FIG. 7 shows one illustrative embodiment of a fluidic light source apparatus;

FIG. 8 shows one illustrative embodiment of a broadband fluidic light source apparatus, including a series of longitudinally-aligned waveguides;

FIG. 9 shows the spectral output from an arrangement as shown generally in FIG. 8, using a series of fluid waveguide fluorescent light sources;

FIG. 10 shows another illustrative embodiment of a broadband fluidic light source apparatus, including an array of adjacent waveguides;

FIG. 11 shows the spectral output from an arrangement of adjacent fluid waveguide fluorescent light sources as shown generally in FIG. 10.

FIGS. 12A-12C illustrate another embodiment of an optical waveguide system;

FIG. 13A shows light exiting a waveguide system as shown generally in FIG. 12A;

FIG. 13B shows a plot of the profile intensity of light output from a waveguide system as shown generally in FIG. 13A;

FIG. 13C shows a contour plot of the refractive index from a waveguide system as shown generally in FIG. 12A;

FIGS. 14A-14D show light exiting a waveguide system comprising dyes;

FIG. 14E shows a plot of normalized absorbance as a function of wavelength of the light exiting a waveguide system as shown generally in FIG. 12A.

FIG. 15A illustrates one embodiment of a waveguide system used for thermally-generated optical waveguides;

FIG. 15B shows a graph of refractive index as a function of temperature;

FIGS. 16A-16B show plots of average normalized intensity of digital micrographs taken from a light output of a waveguide;

FIG. 16C shows a plot of intensity ratio at a light output as a function of total flow rate in a waveguide;

FIG. 16D shows a plot of intensity ratio as a function of temperature in the cladding of a waveguide;

FIGS. 17A and 17B show simulated profiles of refractive index along a longitudinal axis of a waveguide; and

FIGS. 17C and 17D show plots of the calculated temperature and refractive index as a function of distance from the center of a waveguide for three positions along the waveguide.

### DETAILED DESCRIPTION OF THE INVENTION

The present invention is directed to waveguides defined by a fluid core, fluid cladding, or both a fluid core and fluid cladding, and light sources. In some cases, the waveguides can guide and emit a range of electromagnetic wavelengths that is greater than can be produced by a single fluorescent organic dye. In some embodiments, a light source includes waveguides having a fluid core and a fluid cladding (hereinafter alternatively referred to as a “fluid/fluid waveguide”), which, when used together, guide electromagnetic radiation along the waveguide for any of a variety of purposes. In some embodiments, a light source includes waveguides having a fluid core and a cladding that my be either fluid or solid.

Spectroscopy often requires a greater range of wavelengths than can be produced by a single fluorescent organic dye (which usually has a bandwidth of emission on the order of 50 nanometers). In principle, simultaneous emission from several organic dyes with adjacent emission bands could cover an arbitrary range of wavelengths in the UV, visible and near IR spectrum. However, energy transfer from a dye emitting at short wavelength to one emitting at long wavelength, due both to absorption-reemission and resonance energy transfer, limits the usefulness of multiple fluorescent dyes in a common solution.

To avoid the problem of quenching through energy transfer, the dyes may be separated either in frequency or in space. The frequency separation approach uses fluorophores with no overlap between emission and absorption of different dyes. The spatial separation method avoids absorption of emitted fluorescence by collecting the emission of each dye in spatially distinct regions. Spatial separation via laterally arranged arrays and longitudinally arranged series of fluid waveguides may be used for spatial confinement of individual fluorescent light sources. These sources may then be combined, serially or in parallel, for broadband output.

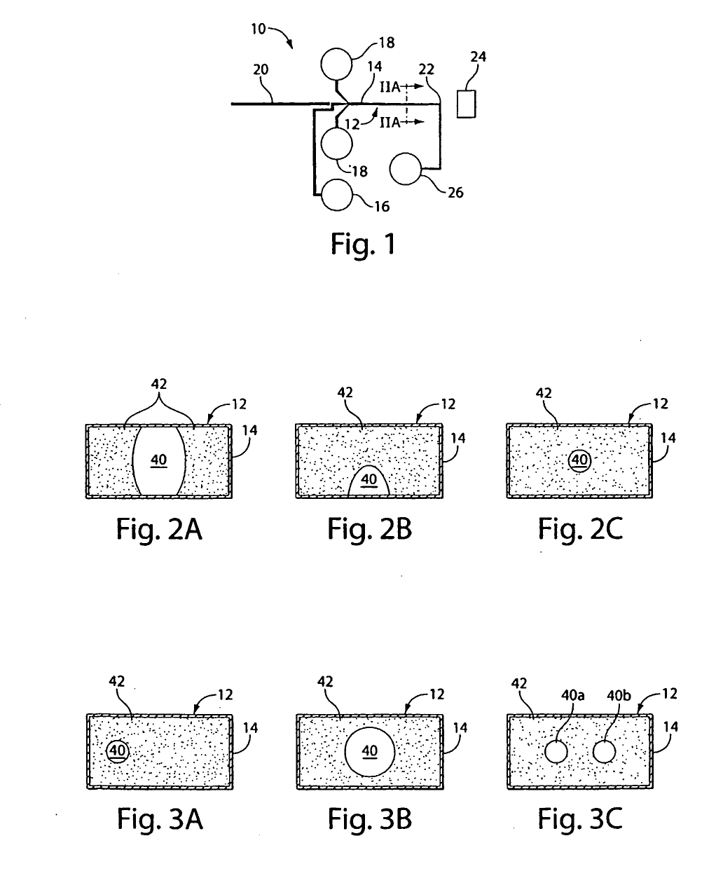

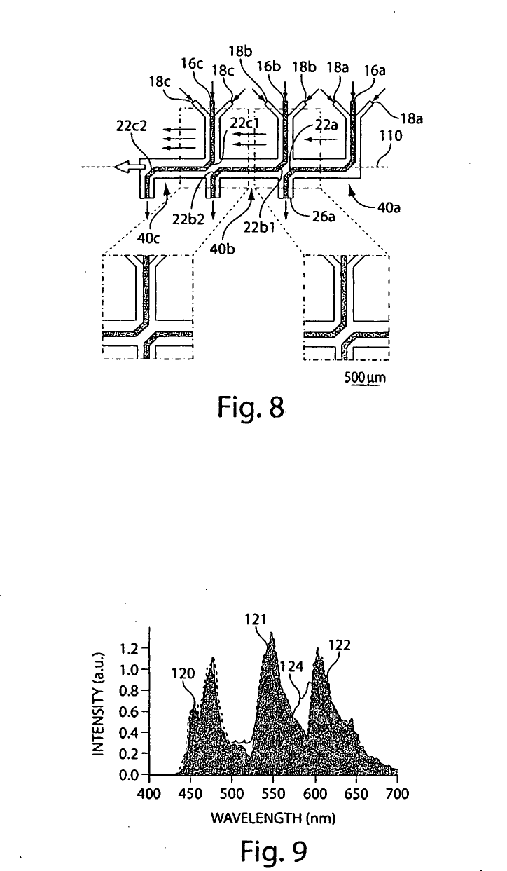

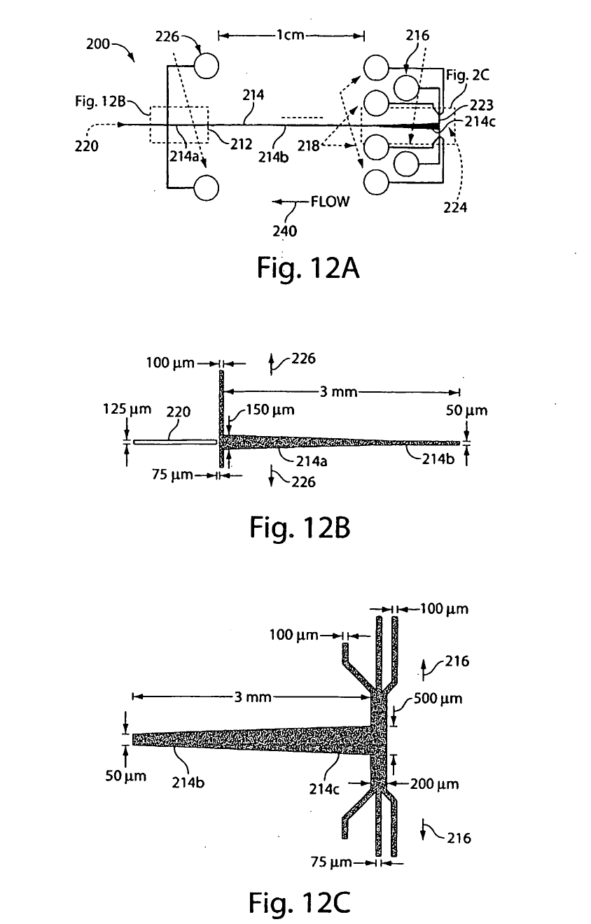

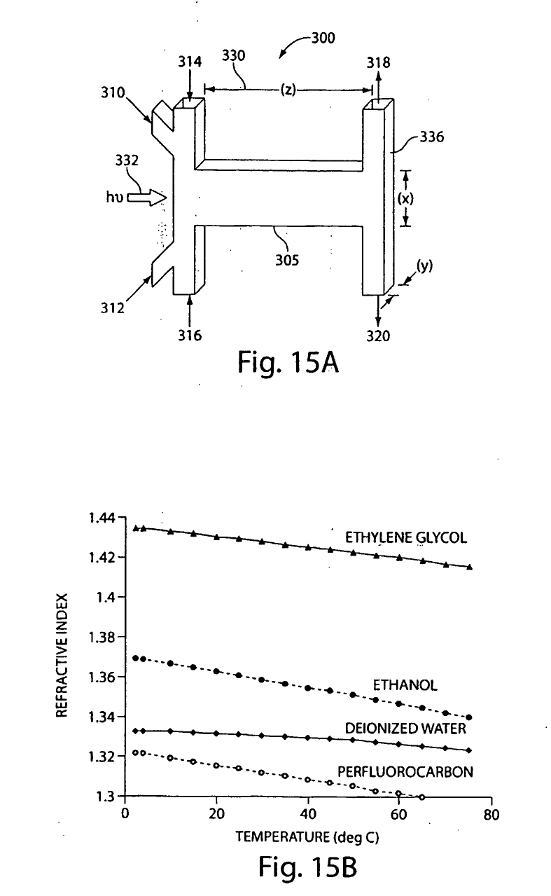

A description of fluid waveguide embodiments and various practical applications are described below with reference to FIGS. 1-7. Broadband fluid waveguide embodiments are described with reference to FIGS. 8-11. Additional fluid waveguide embodiments, including diffusion-controlled optical embodiments and various practical applications, are described with reference to FIGS. 12-14. Embodiments including thermal gradients are described with reference to FIGS. 15-17.

In some cases, novelty of the invention resides in the manner in which a waveguide is arranged, i.e., the components of the waveguide and/or supporting structure, and/or the way in which these components are arranged relative to each other. In other cases, novelty resides in methods/processes involving a waveguide with a fluid core and optionally a fluid cladding. Waveguides of the invention can be used for a variety of purposes, and in some aspects of the invention a particular use or uses, in combination with other features of a waveguide arrangement and/or technique, defines a novel process. Examples of uses include the delivery of electromagnetic radiation to affect or analyze a chemical, biochemical, or biological reaction and/or species, and the transmission of information, e.g., transmission of a time-varying signal that can be decoded.

Those of ordinary skill in the art will recognize that a variety of energy levels (wavelengths) of electromagnetic energy can be used in accordance with the invention, including visible and/or non-visible-light. Where “light” is used in describing a particular embodiment of the invention, it is to be understood this is not limited to visible light.

Where both a fluid core and cladding are used, the core and fluid cladding may be continuously flowing streams of fluid, for example, two or more flowing liquids, two or more flowing gases, or one or more flowing liquid and one or more flowing gas. In these arrangements, a flow of a first fluid of relatively lower index of refraction (the cladding) interfaces with a flow of a second fluid with a relatively higher index of refraction (the core). At low Reynolds numbers, these two fluids can form laminar flows and maintain a stable interface relative to each other, e.g. in a single channel. The structured index of refraction provides the ability to guide light in the high-index fluid stream. Although much of the following description is given in the context of a fluid core or cladding that is a liquid, it is to be understood that in all such cases the invention can be used with another fluid such as a gas. Where liquid waveguide techniques of the invention involve, for example, changing or controlling the concentration of a particular species in the liquid, those of ordinary skill in the art will be able to adapt the technique to fluids that are gases, without undue experimentation. The formation of adjacent fluid streams exhibiting laminar flow is discussed in U.S. Pat. No. 6,719,868, issued Apr. 13, 2004 to Schuler, et al., and U.S. Pat. No. 6,653,089, issued Nov. 25, 2003 to Takayama et al., each of which is hereby incorporated herein in its entirety.

A fluid core and fluid cladding of the invention may comprise a continuous flow of liquids. The continuous flow may allow the waveguides to be dynamically adapted in ways that are not possible with solid-state waveguides. The cladding liquid and core liquid may be introduced into channels of a microfluidic network configured to allow the liquids to flow adjacent to one another. By manipulating the flow rates, the composition of the liquids, and/or the temperature of various components of a waveguide, the characteristics of the optical systems may be dynamically controlled.

In some embodiments, the optical properties (e.g., refractive index, absorption, and fluorescence) and physical properties (e.g., magnetic susceptibility, electrical conductivity, and temperature) of either the core or the cladding, or both, may be changed readily, continuously, and independently by changing the characteristics of the introduced fluids. By changing the optical properties of the fluids, the type of light delivered or generated by a waveguide can be changed. When changing the composition of the core stream and/or the cladding stream, the properties of the fluids may be changed as a function of time, for example a gradual change in the concentration of a dye within a fluid may be effected. Step changes, i.e., changes in fluid property values that occur in a short amount of time, also may be used to change the composition or concentrations in the core and/or cladding streams.

Fluid/fluid waveguide systems may enable the creation of small (<10 micrometers) single-mode waveguides using pressure-driven flow in large (>100 micrometers) and easily fabricated channels. In some embodiments, a channel can have a cross-sectional dimension of less than 100 micrometers. Solid-state devices typically use high-resolution lithographic tools (e.g., laser-or electronic-beam writers) to generate features with the lateral dimensions used for single-mode waveguiding, while microfluidic channels for supporting fluid waveguides may be created using a high resolution printer. As mentioned above, laminar fluid flows generate an intrinsically optically smooth interface between the fluid core and the fluid cladding. Accordingly, the smoothness of the supporting channel walls is not critical. For example, when the roughness of the channel walls is less than 5% of the total width of the channel, the effect of the roughness may be negligible on the core and cladding fluid interfaces. In some instances, the optically smooth interface between the fluid core and the fluid cladding can be advantageous for certain waveguide systems, i.e., for forming an optical splitter, as discussed in more detail below.

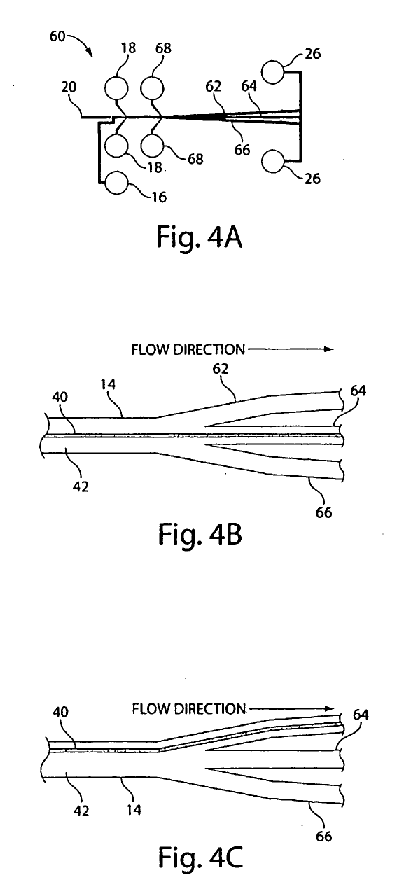

Several working examples were carried out in connection with the invention, according to arrangements as generally illustrated in FIGS. 1, 4, 5, 7, 8, 10, and 12 with results as illustrated in FIGS. 4B, 4C, 6, 9, 11, 13, and 14-17.

FIG. 1 illustrates one embodiment of an optical waveguide system 10 of the invention. A fluid/fluid waveguide 12 is formed within channel 14 by introducing fluid to channel 14 via a core fluid inlet 16 and cladding fluid inlets 18. Fluid may exit optical waveguide system 10 via a fluid outlet 26 or, in other embodiments, via multiple fluid outlets. Channel 14 may be designed to facilitate the coupling of an optical fiber 20 to channel 14 so that electromagnetic radiation such as a light signal may be introduced to waveguide 12. As illustrated in this particular embodiment, optical fiber 20 is positioned relative to channel 14 such that electromagnetic radiation propagates in the direction of fluid flow (i.e., from the fluid inlet to the fluid outlet). It should be understood, however, that a light source such as optical fiber 20 can be positioned in any suitable position relative to the channel, such as in a direction opposite to the direction of fluid flow, as discussed in further detail below. Those of ordinary skill in the art will be able to position fiber 20 relative to channel 14 to achieve this coupling. Waveguide 12 may guide electromagnetic radiation in a waveguide core comprising a fluid. As used herein, “guiding” means providing a pathway such that a significant amount of electromagnetic radiation proceeds along the pathway. Of course, it is expected that some percentage of radiation will degrade or be lost from the pathway via scattering or other means.

Guided electromagnetic radiation may exit fluid/fluid waveguide 12 in an axial direction at a turn 22 that has a radius that is less than the critical radius. The “critical radius” is the radius of curvature of a bend in the waveguide above which electromagnetic radiation propagating within the core is directed at the cladding at an incident angle greater than the critical angle, the critical angle being that angle above which most radiation is contained within the waveguide (referred to in the art as “total internal reflection.”) As used here, “axial direction,” as it applies to a channel, waveguide, pathway, or core, means the general longitudinal direction of the channel or waveguide, in which direction electromagnetic radiation travels. However, a sudden turn in the channel or waveguide such that the turn has a radius less than the critical radius, may result in electromagnetic radiation exiting the waveguide, channel, pathway or core. This exiting at a turn that has a radius less than the critical radius is considered to be an exiting from the channel, waveguide, pathway or core in the axial direction.

At turn 22, fluid/fluid waveguide 12 may deliver electromagnetic radiation from the waveguide core to a delivery site 24. Delivery site 24 may include any of various devices or sites of interest. For example, an optical fiber may be attached to turn 22 or otherwise positioned relative to turn 22 such that light exiting the fiber at the turn is coupled into the fiber. In another example, a chemical, biochemical, or biological reaction or species may be present at delivery site 24, and light delivered to site 24 may be used to analyze contents of the site (e.g. spectroscopically via infrared, UV, fluorescence spectroscopy or the like), or the light may be used to promote a chemical or biological reaction at the site (e.g., a photochemical reaction, a reaction stimulated by heat generated by interaction of the light with the site, etc.), or the like. Those of ordinary skill are aware of many ways in which electromagnetic radiation, delivered by a waveguide of the invention, can be used to affect or analyze a chemical, biochemical, or biological species at a region outside the core of the waveguide, e.g. at a site such as site 24.

Additionally or alternatively, collection devices or analysis tools may be present at delivery site 24. Delivery site 24 may comprise a device constructed and arranged to determine a signal carried by electromagnetic radiation. The signal may be electromagnetic radiation, such as light, which, in some embodiments, encodes a time-varying signal.

Channel 14 and any other associated channels or other components used in connection with the invention may be formed of plastic (e.g., polymeric) materials. These materials also may be flexible, whether plastic or non-plastic. For example, channel 14 may be constructed in an elastomeric material (e.g., an elastic polymer). A variety of elastomeric polymeric materials are suitable for use with the invention, for example, polymers of the general classes of silicone polymers, epoxy polymers, and acrylate polymers. Epoxy polymers are characterized by the presence of a three-member cyclic ether group commonly referred to as an epoxy group, 1,2-epoxide, or oxirane. As specific examples, diglycidyl ethers of bisphenol A may be used, in addition to compounds based on aromatic amine, triazine, and cycloaliphatic backbones. Other examples include the well-known Novolac polymers, silicone elastomeric formed from precursors including the chlorosilanes such as methylchlorosilanes, ethylchlorosilanes, and phenylchlorosilanes, and the like. One preferred elastomeric polymer for use with the invention is polydimethylsiloxane (PDMS). Exemplary polydimethylsiloxane polymers include those sold under the trademark Sylgard by the Dow Chemical Company, Midland, Mich., and particularly Sylgard 182, Sylgard 184, and Sylgard 186. Systems fabricated of PDMS may be fabricated using rapid prototyping and soft lithography. The microfluidic channels may be fabricated in PDMS using standard procedures (for example, see J. C. McDonald, G. M. Whitesides, Acc. Chem. Res. 35, 491 (2002)). Microcontact printing on surfaces and derivative articles and the formation of microstamped patterns on surfaces and derivative articles are discussed in Published Application No. WO/96/29629, published Jun. 26, 1996, and U.S. Pat. No. 5,512,131, issued Apr. 30, 1996 to Kumar et al., each of which is hereby incorporated herein by reference.

A “channel,” as used herein, means a feature on or in an article (substrate) that at least partially directs the flow of a fluid. The channel can have any suitable shape and can be straight, curved, tapered, and the like. The channel can have any cross-sectional shape (circular, oval, triangular, irregular, square or rectangular, or the like) and can be covered or uncovered. In embodiments where it is completely covered, at least one portion of the channel can have a cross-section that is completely enclosed, or the entire channel may be completely enclosed along its entire length with the exception of its inlet(s) and outlet(s). The fluid within the channel may partially or completely fill the channel. The “cross-sectional dimension” of the channel is measured perpendicular to the direction of fluid flow. A channel may have a cross-sectional dimension of less than or equal to 1 mm, less than or equal to 500 micrometers, less than or equal to 250 micrometers, less than or equal to 100 micrometers, less than or equal to 50 micrometers, or less than or equal to 10 micrometers. The size of the channel will depend, of course, on the particular application of a device.

The embodiment illustrated in FIG. 1 includes two cladding fluid inlets 18. In some embodiments, more than two cladding fluid inlets 18 may be used to introduce fluids to form a cladding. In some embodiments, only one cladding fluid inlet 18 may be used. It is important to note that the cladding fluid does not necessarily surround the core fluid in the waveguide. The cladding may be made up in part by a fluid and in part by a solid boundary, such as walls of the channel that supports the waveguide. In some embodiments, waveguide 12 may have no fluid cladding, but rather have a fluid core supported by a solid channel with the channel acting as a cladding. For purposes herein, “wave guide core fluid” means the fluid that has the higher index of refraction, as to compared to the cladding fluid (or other cladding structure), and “waveguide core” means the fluid in which electromagnetic radiation is guided. In some embodiments, the waveguide core fluid may surround the cladding and, e.g., form a ring around the cladding. As used herein, “inlet” means any component, channel, opening, port, or device that allows a fluid to be introduced into an apparatus or a channel. An inlet does not have to be permanently accessible as some embodiments may include inlets that are openable and closeable.

The various apparatus devices and systems described herein often will include fluid reservoirs, fluid pumps, and/or sources of vacuum or reduced pressure to move fluid from the fluid reservoirs to the fluid inlets. Those of ordinary skill in the art are aware of how to arrange such components to practice the invention.

In some embodiments, the physical orientation of the core-relative to the cladding can be changed by altering the flow rates and/or properties of the fluids, for a variety of purposes. For example, increasing the flow rate of one side of the cladding may push the waveguide core laterally within the supporting channel. In another channel, decreasing the flow rate of the waveguide core fluid, and/or increasing the flow rate of the waveguide cladding fluids may decrease the cross-sectional area of the waveguide core. Such changes may allow a user to change the waveguide from a multi-mode waveguide to a single-mode waveguide. Changing the flow rate can also change the amount of diffusion at certain positions within the waveguides. Diffusion between core and cladding fluids maybe be desirable or undesirable depending on the application, as discussed in more detail below. Additionally, movement of the waveguide core within the cladding and/or microchannel may allow for tuning of the location to which light is delivered without requiring the precise placement of an optical fiber. Further, in some embodiments, the number of waveguide cores present within a supporting channel may be changed without changes to the supporting channel. FIG. 2A shows a cross-sectional view taken along line IIA-IIA of FIG. 1, illustrating one embodiment of waveguide 12 including a waveguide core 40 and a cladding 42, for purposes of illustrating examples of physical orientation of the core relative to the cladding, fluids that can be selected for use for each, etc. Waveguide core 40 and cladding 42 are supported within channel 14 of a supporting material. As examples of fluids that can be used in the invention, deionized water (n_{d}=1.335) can be used for cladding 42, and an aqueous solution of CaCl₂ (5 M, n_{d}=1.445), can be used for core 40. Water does not swell PDMS, and thus in embodiments employing PDMS as a supporting material, the water does not affect the mechanical properties of the PDMS or the dimensions of the microfluidic channels. The refractive index of the CaCl₂ solution is greater than the refractive index of PDMS (n_{d}=1.40), and thus in embodiments where core 40 is close to or contacts walls of channel 14, light does not escape from core 40. At low flow rates, the interface between deionized water and an aqueous solution of CaCl₂ is smooth.

In an embodiment including two cladding fluid inlets 18, i.e., as illustrated in FIG. 1, fluid flow of the core and cladding can be controlled such that waveguide core 40 is positioned in any manner relative to the cladding (and/or supporting structure defining a channel containing both), e.g., the core can be positioned symmetrically within channel 14. Additionally, portions of waveguide core 40 may be adjacent to walls of channel 14, for example, at the top and bottom of core 40, or only at the bottom of core 40, or only at the top of core 40, or at both sides of core 40, or only at one side of core 40, as the channel wall can contact the core, and in this arrangement both the channel wall of the supporting structure and the fluid cladding act together as a cladding or claddings to confine light to the core. As used herein, “adjacent” means nearby. The term “adjacent” is not meant to require a common border or interface, but can include a common border or interface. For example, a cladding liquid stream may be adjacent to a core liquid stream even if a third component such as a thin solid or an additional liquid stream is interposed between the cladding stream and the core stream.

Differences in the densities of the waveguide core fluid and cladding fluid may cause core 40 to float or sink within channel 14. As illustrated in FIG. 2B, core 40 may be physically oriented at the bottom of cladding 42. As illustrated in FIG. 2C, the use of isodense fluids may minimize the influence of gravity on the system, allowing core 40 to be completely surrounded by cladding 42, e.g., contained symmetrically within the cladding.

In some embodiments, immiscible liquids may be used for waveguide core 40 and cladding 42 to help reduce diffusion between the fluids that can reduce the ability of a waveguide to function. Reducing diffusion can create a sharp concentration gradient and a corresponding sharp refractive index gradient between the fluids. For example, silicone oil (DC200, n_{d}=1.401, 10 mPa·s, Fluka) may be used for cladding 42 while using an ethylene glycol solution containing a fluorescent dye for core 40. The improved diffusion characteristics should be balanced, however, with the potential instability of the fluid-fluid interface between immiscible fluids, as compared to miscible fluids. In some cases, this potential instability may make immiscible fluids more difficult to use than miscible fluids at certain flow rates, in longer microchannels (e.g., >5 centimeters), and in high aspect ratio microchannels (e.g., height/width≧1).

Another method of reducing issues associated with diffusion is to increase the flow rates of the core and/or the cladding to reduce residence times in the waveguide.

In some cases, diffusion between portions or characteristics of waveguide core and cladding fluids is desirable. In such cases, it maybe be suitable to use core and cladding fluids that are miscible. For example, in one embodiment, diffusion between the core and cladding fluids creates a refractive index gradient in a waveguide. This refractive index gradient can be used to generate an optical splitter and a wavelength filter, as discussed in more detail below.

Fluid flows for the waveguide core and the waveguide cladding may flow in the same or opposite directions of one another. The fluid flow rates for the core and the cladding may be similar or may be substantially different. In some embodiments, the fluid for one of the core and the cladding may be stationary, while the fluid for the other of the core and the cladding may flow at a certain flow rate. In some embodiments, fluid may flow intermittently or not at all for either or both of the core and the cladding.

A non-limiting example of a fluid/fluid waveguide including stationary fluids is the following. A waveguide core fluid and a fluid cladding can be flowed into a channel to form a waveguide. Flow of the fluids can be stopped and then light can be guided through the core. The fluids can remain stationary since the flow has been stopped and if, for instance, the fluids are highly viscous. Although diffusion can still take place in this system, diffusion may be slow on the time scale of the light guiding process. Of course, the ability of the waveguide to guide light in the core will depend on factors such as the particular fluids used (i.e., viscosity of the fluids and the rate of diffusion of the molecules in the fluid), the cross-sectional dimensions of the channel (i.e., the path-length of diffusion), etc.

FIGS. 3A-3C show examples of changes to the physical orientation of core 40 relative to cladding 42 that may be produced through various methods. For example, the physical orientation of core 40 relative to cladding 42 in FIG. 3A may be achieved by increasing the fluid flow rate through one cladding fluid inlet 18 while maintaining or decreasing the fluid flow rate through a second cladding fluid inlet 18. The changes to the flow rate(s) may push core 40 to a different physical orientation relative to cladding 42. Controlling the physical orientation of core 40 relative to cladding 42 may enable a user to more precisely position the electromagnetic radiation output of waveguide 12 without requiring movement of channel 14 or precise alignment of channel 14 with a delivery site.

Another example of a change to the physical orientation of core 40 relative to cladding 42 is shown in FIG. 3B. In this example, the cross-sectional area of core 40 is increased as compared to core 40 illustrated in FIG. 2C. This increase in the cross-sectional area of core 40 may be achieved by increasing the flow rate of the core relative to that of the cladding, e.g., increasing the flow rate of core 40 and/or decreasing the flow rate of cladding 42. The relative densities of the core and cladding fluids also may be changed to alter the size and/or shape of core 40 relative to cladding 42. By changing the cross-sectional area of core 40, modal changes to the waveguide can be effected, as well as other changes that those of ordinary skill in the art will recognize. E.g., waveguide 12 can be changed from a single-mode waveguide to a multi-mode waveguide. Additionally, such a change may be reversible, that is, cross-sectional area of core 40 may be returned to its original cross-sectional area. For example, core 40 may have a diameter of 8 micrometers in single-mode guiding of light having a wavelength of 780 nanometers, while larger diameter cores may carry multiple modes, such as 5 or 40 modes, for example. These changes (and other changes affecting fluid cores and/or claddings of the invention) can take place dynamically, i.e., while the waveguide is being used to propagate light. These changes can also take place between uses. I.e., a waveguide of the invention can be used for one purpose requiring single-mode light propagation, the waveguide can be changed to a multi-mode guide by changing fluid flow rates thereby changing the size of the core relative to the cladding, and the waveguide can then be used for multi-mode purposes.

Waveguide 12 will be described mostly in the context of the physical orientation of FIG. 2C, but it is to be understood that any of the cross-sectional illustrations of FIGS. 2A-2C and 3A-3C, or other suitable cross-sectional waveguide physical orientations could be used in any of the embodiments described herein.

As another example of changing the physical orientation of the core relative to the cladding, core 40 may be split into multiple cores 40, as illustrated in FIG. 3C. An additional cladding fluid inlet may be used to introduce a cladding fluid flow that splits core 40 into two waveguide cores 40a and 40b. This can be used to control the delivery of radiation to different sites, to carry out a switching function as described below, or the like. Other methods of splitting a waveguide core are described in more detail below.

In some embodiments, optical switches may be created with fluid/fluid waveguides such that the path of the waveguide can be switched without electrical or thermal input. For example, by manipulating the rate of flow of one or more of the fluid streams, the path of the waveguide can be switched from one channel branch to another channel branch. Specifically, one application of changing the physical orientation of the waveguide core relative to the cladding is the construction of a microfluidic switch apparatus. FIG. 4A illustrates one embodiment of a microfluidic switch apparatus 60. In some embodiments of switch apparatus 60, changes to flow rates direct waveguide core 40 along different branches of channel 14. For example, a first branch 62, a second branch 64, and a third branch 66 may extend from channel 14. Under initial flow conditions, waveguide core 40 may flow from channel 14 into second branch 64 as shown by way of example in FIG. 4B. By increasing the flow rate of one side of cladding stream 42, core 40 may be driven by fluid pressure resulting from this flow such that it flows into first branch 62, as shown by way of example in FIG. 4C.

An increase in the flow rate of cladding stream 42 may be achieved by increasing the flow rate from one of cladding inlets 18. In some embodiments, additional inlets 68 may be included in switch apparatus 60. Inlets 68 may introduce additional cladding fluid downstream of cladding inlets 18. By carefully controlling flow rates, switching of a variety of speeds can be achieved. For example, microfluidic switch apparatus 60 can be used to switch fluid flow from one branch to another in less than approximately two seconds.

Apparatus 60 can be constructed in a variety of dimensions. For example, channels such as channel 14 may have cross-sectional dimensions of approximately 300 micrometers and branches 62, 64, 66 may have cross-sectional dimensions of approximately 150 micrometers. Inlets 68 may have channel cross-sectional dimensions of approximately 100 micrometers. Any suitable cross-sectional dimensions for channel 14 and/or branches 62, 64 and 66 may be used in connection with microfluidic switch apparatus 60. Microfluidic switch apparatus 60 may include 2, 3, 4, or more branches.

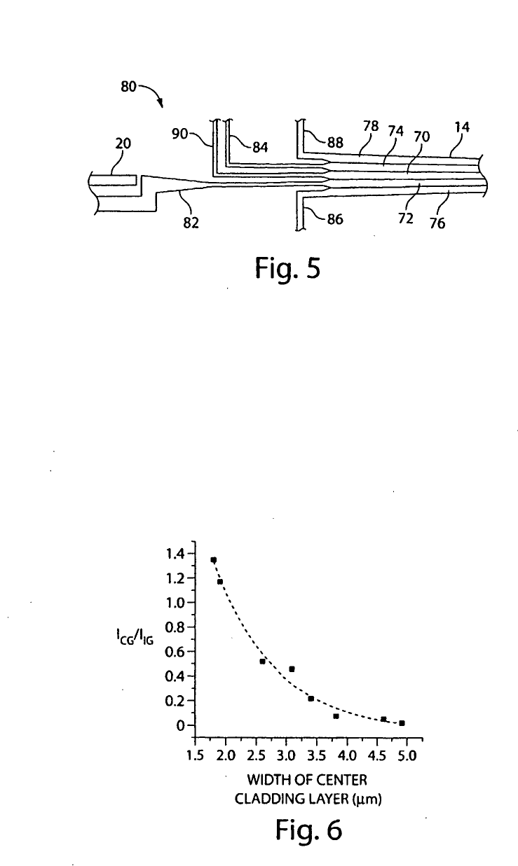

An evanescent coupler may be created using techniques and/or apparatus of the invention using two fluid/fluid waveguides that share an inner cladding stream. Electromagnetic radiation is introduced into one of the fluid waveguides (the “illuminated waveguide”), and, if the inner cladding stream is sufficiently thin, the evanescent fields of the two cores overlap and light may transfer from the illuminated waveguide to the evanescently-coupled waveguide. FIG. 5 illustrates one embodiment of an evanescent coupler apparatus 80 of the invention that includes two fluid/fluid waveguides which share an inner cladding 70. Channel 14 may include a first core 72, a second core 74, a first outer cladding 76, a second outer cladding 78, and an inner cladding 70. Coupler apparatus 80 includes a first core inlet 82, a second core inlet 84, a first outer cladding inlet 86, a second outer cladding inlet 88, and an inner cladding inlet 90. Electromagnetic radiation, such as a light signal, may be introduced into first core 72 with optical fiber 20. First core 72 is referred to as the “illuminated waveguide”. A suitably thin inner cladding stream 70 along a coupling region may allow the evanescent field of first core 72 and second core 74 to overlap and thereby transfer electromagnetic radiation from the illuminated waveguide to the evanescently-coupled waveguide (which includes second core 74). For example, inner cladding inlet 90 may have an approximately 50 micrometer wide channel which may enable the formation of an inner cladding stream of less than approximately 2 micrometers width to facilitate efficient coupling. FIG. 6 shows graphical results of trials run with one embodiment of evanescent coupler apparatus 80. The graph in FIG. 6 shows ratios of the intensities of light emitted from the end of channel 14 by each fluid/fluid waveguide (illuminated waveguide (I_{IG}) and evanescently-coupled waveguide (I_{CG})) as a function of the width of inner cladding stream 70.

Instead of, or in addition to, a suitably thin inner cladding stream, a suitably low value of refractive index contrast between the core and the cladding may allow evanescent coupling of the illuminated waveguide and coupled waveguide. Refractive index contrast is a measure of the relative difference in the refractive index of the core and the cladding, and is given by:

(n₁²−n₂²)/2n₁²),

where n₁ is the maximum refractive index in the core and n₂ is the refractive index of the cladding. For example, if the refractive index contrast is approximately 0.01 and inner cladding stream 70 has a width of less than approximately 2 micrometers, evanescent coupling may occur. The refractive index contrast may be lowered by the diffusion of solutes such as CaCl₂ from the core into the cladding in the coupling region.

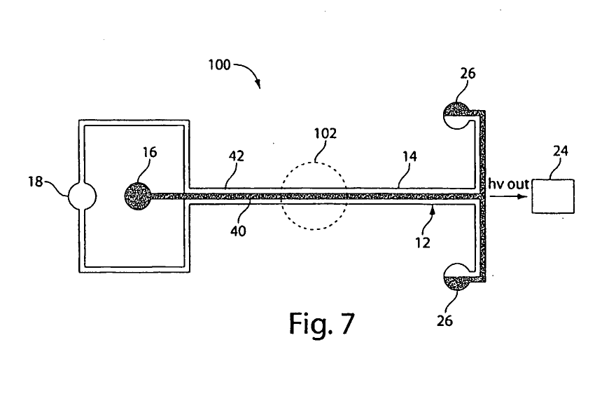

FIG. 7 shows one illustrative embodiment of a fluidic light source apparatus 100 as another example of a fluid waveguide. Fluidic light source apparatus 100 may be integrated into a microsystem, such as a “lab-on-a-chip,” in some embodiments. “Lab-on-a-chip” refers to microfluidic systems built on or into generally planar, small substrates that may include valves, pumps, channels, channel intersections, etc., for the purpose of carrying out reactions or analyses that are known in the art, or new reactions or analyses, on a very small scale that, in the past, had typically been carried out only on a larger scale (e.g., at least a “benchtop” scale). A waveguide may be integrated onto or interfaced with such a chip such that components of the systems described herein are brought into appropriate proximity of the components of the chip. The waveguide may be irradiated from an axial or a non-axial direction such that the waveguide's light can be used on the chip to affect or analyze a biochemical, chemical, or biological reaction or species on such a chip or in a different environment. In these systems, light emission, collection and propagation may each occur within the fluid core. In some systems, a fluid core waveguide may be used to provide an interface between a light source and a microsystem. Fluid core waveguide light sources and/or interfaces may provide an increased versatility or tunability as compared to known light source interfaces such as optical fibers.

Apparatus 100 may be configured in a similar manner to the apparatus described above with reference to FIG. 1, with a few variations. Instead of, or in addition to, including optical fiber 20 to introduce electromagnetic radiation to waveguide core 40, a light source (not shown) may irradiate an optical pump region 102 to produce electromagnetic radiation. Waveguide core 40 may include a core liquid that contains a fluorescent dye. As waveguide core 40 is irradiated (“optically pumped”) with a collimated beam, a fraction of the resulting fluorescence can be guided through core 40 to delivery site 24. Any of the cross-sectional configurations shown in FIGS. 2A-2C and 3A-3C, or any other suitable cross-sectional configuration may be used in conjunction with fluidic light source apparatus 100.

Fluidic light source apparatus 100 may provide one or more of several functions. For example, the fluorescent dye used within waveguide core 40 may be changed in real-time without fabrication of a new device by introducing a different dye through core fluid inlet 16. The use of different dyes may enable the production of different spectral ranges of light while using one apparatus. The simultaneous inclusion of multiple dyes in the fluid streams may also be used in apparatus 100 to generate a broadband light source. In some embodiments, apparatus 100 may generate output intensities comparable to standard fiber-optic spectrophotometer-based light sources, without requiring manual insertion and alignment of an optical fiber. In certain embodiments, the inclusion of multiple dyes can be used to generate a subtractive wavelength filter, as described in more detail below.

In microfluidic chips that interface with known optical fiber light source, the receptor channel of the chip typically is matched in size and location to the optical fiber light source. For example, an off the shelf 100-120 micrometer optical fiber may be used to interface a light source to a microfluidic chip. In such a case, the receptor channel diameter should be approximately 100 micrometers. Fluidic light source apparatus 100 may provide a light source interface that is adjustable by changing the physical orientation of the core relative to the cladding to match the location and/or size of the light source interface to the receptor channel of the microfluidic chip.

Fluidic light source apparatus 100 of the invention may be useful with a microfluidic device, such as a microfluidic device mounted on a chip. For example, because apparatus 100 can be fabricated in an integral manner on a chip, and the collimated beam or other light source need not be precisely aligned to optically pump the optical pump region 102, there may be no need to carefully align an external radiation source to a microfluidic device.

In some embodiments of fluidic light source apparatus 10, a quartz halogen lamp (150 watts, Cuda) was used to direct a collimated beam perpendicularly to an axial direction of waveguide core 40. The collimated beam or other light source need not be directed perpendicularly as it may be directed at any suitable angle to the axial direction of waveguide core 40. In some embodiments, an ethylene glycol solution (n_{d}=1.432) containing Rh6G (0.1-10 mM) was used for waveguide core 40. Deionized water was used for cladding 42 in some cases. The miscibility of ethylene glycol and water may help to maintain a stable interface in a laminar flow regime, although mutual diffusion of the two liquids may lead to changes in the refractive index contrast along the length of channel 14. Channel 14 was constructed of PDMS in some working examples, and in an embodiment including an ethylene glycol solution with Rh6G deionized water, PDMS and a 150-watt quartz halogen lamp, waveguide 12 can in principle capture approximately 3.5 percent of the emitted light.

A variety of general features and options are provided in accordance with the invention. The continuous flow of fluids enables the replacement and/or change of dopants within a waveguide. For example, some dopants degrade via photobleaching, and the continuous addition of new dopants to the fluid flows may help maintain the dopant concentration at a suitable level.

According to another aspect of the invention, control of spectral output of a light source via selective combination of any of a number of light sources, for example to produce broadband light sources may be constructed by using at least one fluid waveguide. Multiple fluid waveguides may be arranged in any manner such that their individual or combined outputs can be used as desired, for example in generally end-to-end or side-by-side arrangements, with each waveguide containing a different fluorophore. By creating different fluorescent light in spatially separate waveguides, problems associated with energy transfer from fluorophores emitting at shorter wavelength to fluorophores emitting at longer wavelength can be reduced or in some cases eliminated. A broadband light source may be constructed by combining the light output of each fluid waveguide.

In some embodiments, a broadband light source includes end-coupled fluid waveguides. Fluorescent light that is emitted (produced) by fluorophores within a waveguide and emitted (output) from the fluid waveguides is transferred into the next fluid waveguide that is present in series along the longitudinal direction of the series of waveguides. Because the production of fluorescent light takes place in separate fluid waveguides, problems associated with energy transfer between fluorophores can be reduced and in some cases eliminated.

One embodiment of an apparatus constructed and arranged to emit (output) broadband electromagnetic radiation by end-coupling multiple fluid waveguides is illustrated in FIG. 8. In the embodiment illustrated, first, second and third waveguides 40a, 40b, and 40c are arranged so that each waveguide has a section that is aligned with a longitudinal direction 110. While three separate waveguides are shown to be aligned longitudinally in this embodiment, in some embodiments greater numbers of waveguides may be employed, and in other embodiments, fewer waveguides may be used.

For first waveguide 40a, fluid used to form a cladding 42a is introduced at cladding fluid inlets 18a, and fluid used to form a core 40a is introduced at core fluid inlet 16a. The cladding fluid and core fluid may exit from the waveguide at fluid outlet 26a.

First waveguide 40a is irradiated (for example, as discussed above with reference to FIG. 7) so as to cause the fluorophores to fluoresce and emit fluorescent light. The fluorescent light is guided along waveguide 40a until it reaches a turn 22a that has a radius that is less than the critical radius within which total internal reflection or nearly total internal reflection can be maintained, at which point the light exits (is emitted from) waveguide 40a. The fluorescent light enters second waveguide 40b via a turn 22b1. Second waveguide 40b is irradiated to create (emit) fluorescent light, and if the fluorescent light of second waveguide 40b includes wavelengths not present in the light of first waveguide 40a, the two light spectra are added together to form a broader light spectrum. The same process occurs for a third waveguide section 40c, and the light spectrum representing the combination of the three irradiated waveguide sections is emitted from third waveguide 40c a turn 22c2.

Starting with the lowest-energy dye in first waveguide 40a and successively moving to higher-energy dyes helps to avoid absorption of the higher-energy fluorescence as it moves through the waveguides. The reverse (highest to lowest) order results in more absorption.

The embodiment illustrated in FIG. 8 includes two cladding fluid inlets for each waveguide. In some embodiments, more than two cladding fluid inlets may be used to introduce fluids to form a cladding. In some embodiments, one cladding fluid inlet alone may be used. It should be noted that the cladding fluid does not necessarily surround the core fluid in the waveguide.

FIG. 9 displays the spectral output of a series of fluid waveguide light sources under different illumination conditions. Each fluid waveguide had methanol (n_{D}=1.329) in the cladding streams and a 0.5 mM fluorescent dye in DMSO:EG, 1:1 (n_{D}=1.455) in the core stream. The fluorophores in each section of the waveguide (from first to last, for example right to left in the embodiment of FIG. 8) were perylene (blue emission), fluorescein (green emission), and silforhodamine B (red emission). Individual dashed-line peaks 120, 121, 122 in FIG. 9 are the total output of the device when only one dye was excited by irradiating one waveguide of the three. The spectral output of the device when all three waveguides were illuminated is shown by a solid 124 line in FIG. 9, which constitutes an essentially continuous emissive band from the shortest wavelength of emission of the highest energy emissive dye to the longest wavelength of emission of the lowest energy emissive dye. The solid line matches well with the sum of the three individual peaks, indicating that absorption-reemission and resonant coupling have been reduced through spatial separation of the fluorescent dyes. “Essentially continuous emissive band,” as used herein, means an emissive band within which substantial emission occurs at each wavelength within the range, for example, emission at all wavelengths at least about 3% as intense as the intensity of greatest emission within the range, or at least about 5%, 10%, 15%, 20%, 25%, 30%, or 40% of greatest emission.

As mentioned, one aspect of the invention involves emission, from a waveguide which can be a fluid waveguide, of electromagnetic radiation in an essentially continuous band covering at least 150 nanometers. In some embodiments the essentially continuous band can cover at least 175 nanometers or 200, 225, 250, 275, or 300 nanometers. The arrangement of which FIG. 9 represents the spectral output exhibits an essentially continuous band covering at least about 250 nanometers.

The longitudinal series of fluid waveguide fluorescent light sources may allow a single set of dyes to cover the entire visible spectrum by large-area illumination, or to produce a range of narrow spectral outputs by selective illumination. Some restrictions on the selection of dyes may exist when emissions from the low-energy dyes pass through another dye. Thus, the high-energy fluorophores are preferably transparent at low frequencies, because high concentrations of dyes (mM, corresponding to attenuation depth of ˜100 μm) are preferred in these devices to increase emitted optical power.

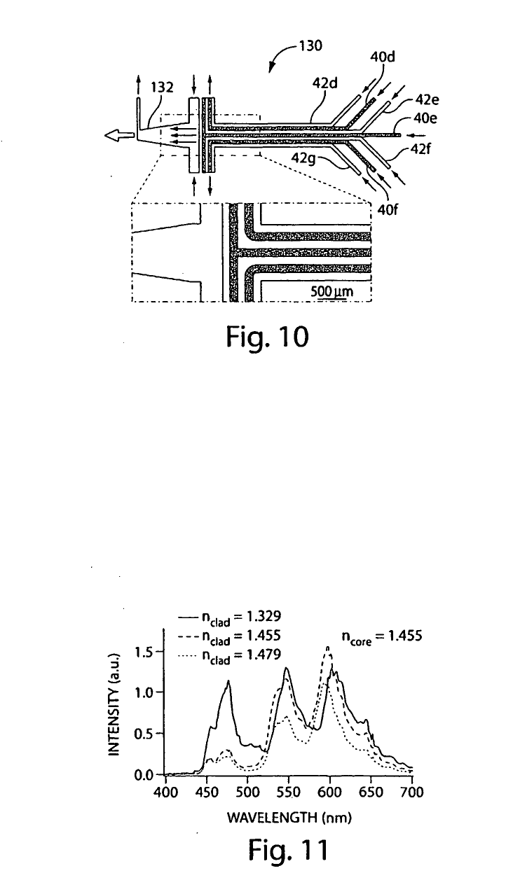

An alternative embodiment to the longitudinal series arrangement is an array arrangement, as illustrated in FIG. 10, which can provide broadband output with a shorter length apparatus. In this embodiment, an apparatus 130 includes substantially adjacent dye-containing core streams 40d, 40e, 40f which are separated from each other by shared cladding streams 42d, 42e, 42f, 42g, and are aligned along their longitudinal direction. In this arrangement, the physical separation of the separate dye-containing core streams from each other results in fluorescent emission from each dye remaining separate. That is, fluorescent emission from each dye does not travel along another core of the waveguide containing another dye.

For spectroscopic characterization and potential applications, the light-outputs of all of the fluid waveguides in the array may be merged so that they may be fed into a single optical fiber or analyte compartment, such as a 125-μm optical fiber. A tapered, spatially distinct, fluid waveguide 132 may be end-coupled to the waveguide array. The channel may end in a T-split to act as an adapter to combine the emissions of the parallel waveguides, concentrating them on an optical fiber. The tapered fluid waveguide may contain a stationary liquid with index of refraction higher than PDMS (e.g. DMSO, n_{D}=1.479), to assist light from each of the fluid waveguides in the array in reaching the end-coupled optical fiber.

The overall spectral characteristics, as measured by a fiber-optic spectrometer for one experiment using the apparatus of FIG. 10 and demonstrating an essentially continuous emissive band covering at least about 250 nanometers, are shown in FIG. 11. Tuning of the spectral output may be achieved, for example, through regulation of dye flows and/or concentrations, including removal of selected dye(s) from the array. An increase or decrease in the relative flow-rate of a dye in the array results in a higher or lower volume fraction of this dye in the waveguide and, subsequently, increases the decreases or light output in that particular part of the spectrum. Stopping the flow of one of the liquid cores results in omission of the corresponding peak from the combined spectrum.

FIG. 11 shows the spectral output (solid line) from an array of fluid waveguide fluorescent light sources arranged as in the apparatus shown in FIG. 10 and containing 0.5-mM solutions of perylene, fluorescein and sulforhodamine B in DMSO:EG (1:1), with various cladding liquids: methanol (n_{cladding}<n_{core}); DMSO:EG (1:1, (n_{cladding}=n_{core}); DMSO (n_{cladding}>n_{core}). Flow rates for all inputs were held constant at 4 mL/h each.

In certain embodiments, a waveguide system can be constructed and arranged to enable splitting of a waveguide core and/or joining of two waveguide cores. In some cases, an optical interface can be removed between two cores. In one embodiment, an optical waveguide system includes a channel for supporting at least one fluid waveguide and an adjacent fluid cladding, the channel having an axial direction and comprising a core fluid inlet for receiving a fluid that forms a core, a cladding fluid inlet for receiving a fluid that forms a cladding, and at least one fluid outlet. Different methods of splitting the waveguide core and/or joining two waveguide cores are provided herein. For instance, in one embodiment, splitting of a waveguide core can occur as a result of introducing a cladding fluid flow that splits a core into two waveguide cores, as discussed earlier in reference to FIG. 3C.

In another embodiment, the joining of two cores can occur without requiring additional electrical, thermal, or fluid input, i.e., after the core and cladding fluids have been introduced into a channel. For instance, in one embodiment, a waveguide system may comprise first, second, and third fluid waveguide cores adjacent a fluid cladding, the first, second, and third cores able to guide electromagnetic radiation and the second and third cores joining the first core at a splitting junction. Formation of the first core may occur by diffusion of at least one portion or characteristic of a fluid defining the second core, and/or a portion or characteristic of a fluid defining the third core (i.e., joining of the second and/or third cores portions). The gradients formed by diffusion can manipulate light traveling parallel to the direction of flow of the fluids, or perpendicular to it. Such optical waveguide systems can be used to generate tunable optical splitters, wavelength and spatial mode filters, and other optical devices based on diffusion, as described below.

FIGS. 12A-12C illustrate one embodiment of the invention including optical waveguide system 200. In the embodiment illustrated in these figures, a fluid/fluid waveguide 212 can be formed within channel 214 by introducing fluid into channel 214 via core fluid inlets 216 and cladding fluid inlets 218. Fluid may exit optical waveguide system 200 via fluid outlets 226.

In the embodiment illustrated in FIG. 12A, first and second fluids, e.g., ethylene glycol (neat) and an 85:15 by weight ethylene glycol:water mixture, are miscible and can be flowed into the two core fluid inlets 216 and the four cladding inlets 218, respectively, of waveguide system 200. The flow of these fluids (i.e., in the direction of arrow 240) can cause the formation of first and second waveguide cores adjacent a fluid cladding, i.e., near upstream region 214C. In this system, diffusion of at least a portion or characteristic of the core and cladding fluids (i.e., diffusion of ethylene glycol and water) at the interface between the core and cladding streams can create a controllable concentration gradient and a corresponding refractive index gradient. The extent of diffusion increases in the direction of arrow 240. In some cases, the refractive index gradient, formed as a result of diffusion, causes the formation of a third core within the waveguide, i.e., near downstream region 214A. The first and second cores can join the third core at a splitting junction of the waveguide, i.e., near region 214B.

In the embodiment illustrated in FIGS. 12A-12C, channel 214 facilitates the coupling of an optical fiber 220 to channel 214 so that electromagnetic radiation such as a light signal may be introduced to waveguide 212. In this particular embodiment, light propagates in a direction opposite to the direction of flow of the fluids, and thus moves in the direction of decreasing extent of diffusive mixing (i.e., axially in the direction of the outlets to the inlets along channel 214, in the direction opposite of arrow 240). At turns 223, the light can exit the waveguide through delivery site 224, which can be a transparent window, a reaction site, an optical fiber, or the like.

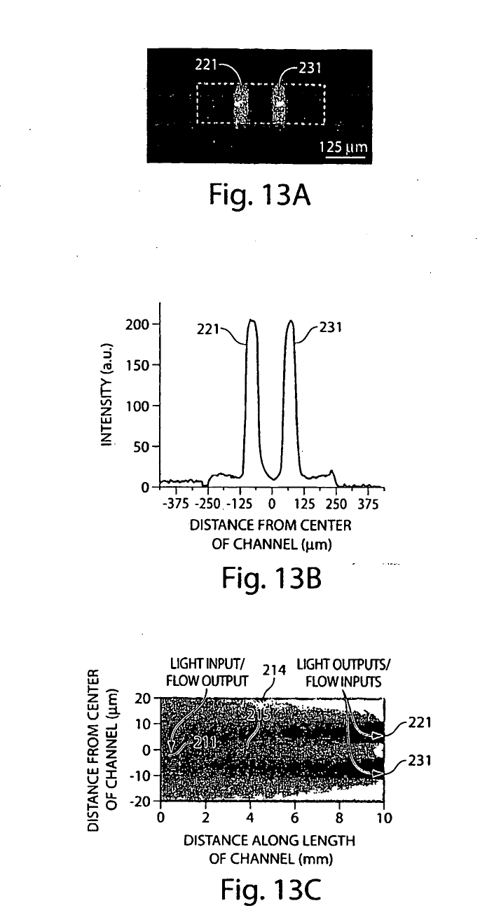

In one embodiment, waveguide system 200 can cause a single source of white light to be split into two output beams with equal intensities, as shown in FIGS. 13A-13C. For instance, light from optical fiber 220 can be guided by third waveguide core 211 (i.e., as shown in FIG. 13C) formed by the diffusion of first waveguide core 221 and second waveguide core 231, as described above. As light propagates through the third core to splitting junction 215, the light can split into cores 221 and 231. FIG. 13A shows an optical micrograph of light exiting through cores 221 and 231 of the microfluidic channel of system 200, viewed through delivery site 224. The dashed box shows the walls of channel 214. In this particular embodiment, the light (λ=780 nm) was coupled into the waveguide from a single-mode optical fiber. The rates of flow of the core fluids were 2.5 μL/min, of the central cladding fluids was 5 μL/min, and of the outer cladding fluids were 20 μL/min. FIG. 13B shows a plot of the profile of the intensity of light output as a function of distance from the center of the channel.

FIG. 13C also shows a result of modeling the effect of diffusive mixing on the profile of the refractive index along the length of channel 214 of system 200 to determine how the flow rates of the core and cladding fluids affect this profile. A contour plot of the refractive index is shown as a function of the distance from the center of the width of the channel and of the distance along the length of the channel. The gradient of color from black to white indicates values of the refractive index from 1.431 to 1.414. As described above, mutual diffusion of the components of the core and cladding fluids can change the profile of the refractive index across channel 214 from that of two separate waveguides 221 and 231 at the light output to that of single waveguide 211 at the light input. I.e., a system is formed, with the aid of diffusion, comprising first and second cores joined at a splitting junction to a third core.

Advantageously, in some embodiments, it is possible to control the residence time of the fluids in the channel and the separation between two fluid cores in real time. This capability can determine the extent of diffusive mixing of the fluid/fluid waveguide components, and thus the extent of the refractive index gradient.

As described above, diffusion of at least one portion or characteristic of a fluid can include diffusion of molecules defining the waveguide core fluid and/or the cladding fluid (i.e., the mutual diffusion of ethylene glycol and water across the core and cladding streams). In other embodiments, diffusion of at least one portion or characteristic of a fluid can include can also include diffusion of a solute in a fluid (e.g., a salt), diffusion of a precipitate in a fluid, and/or diffusion of a thermal characteristic of a fluid (i.e., conduction of heat). These methods of diffusion can be used to change refractive index of a fluid in certain embodiments.

In some cases, mutual diffusion can take place between core and cladding fluids. For instance, as described above, if a core and cladding fluid are miscible, at least a portion of a core fluid can diffuse into a cladding fluid and at least a portion of a cladding fluid can diffuse into a core fluid.

In other cases, diffusion of a substance is favored in one direction. For instance, for a fluid/fluid waveguide containing immiscible fluids, a core or a cladding fluid can contain a solute that is soluble in one fluid, but is less soluble or non-soluble in the other. In one embodiment, the rate of diffusion of a solute takes place faster than the rate of diffusion of the solvent (i.e., the core or cladding fluid). For example, a core or cladding fluid can be highly viscous (and, therefore, have a low diffusion coefficient and be slow to diffuse) and contain a solute that has a high diffusion coefficient that diffuses relatively faster. Thus, change of refractive index can occur as the solute diffuses between the core and cladding fluids. The change of refractive index in the waveguide can depend, of course, on dimensions of the waveguide and the flow rates of the fluids, which can be controlled by the user.

A contributor to the splitting of light (or the joining of two waveguide cores), i.e., as demonstrated in FIG. 13, may be the smoothness of the interface between the core and cladding streams and the smoothness of transition from a single waveguide to two equivalent waveguides. This smooth gradient contrasts with the sharp boundaries in most solid-core, solid-cladding optical splitters. In this particular embodiment, the angle of the Split of the waveguides was estimated to be <0.5°. The half-angle of the split can be estimated by calculating arctan(x/y), where x was the distance along the length of the channel where the refractive index contrast between the center of one core and the center of the channel (Δn=nₘₐₓ−nₘᵢₙ) was ˜0.001 and y was the distance along the width of the channel from nₘₐₓ to nₘᵢₙ. Advantageously, this angle can be tunable (e.g., to split at angles of less than 0.25°, less than 0.5°, less than 1°, less than 1.5°, less than 2°, or less than 5°) by adjusting the flow rates or geometry of the channel 214. In some cases, equal splitting of the light source can be performed using slow rates of flow (<10 μL/min, τ>0.375 s) of the core and central cladding streams. In other cases, unequal splitting is desirable and can be obtained, for instance, by adjusting relative flow rates.

Optical devices fabricated from fluid/fluid waveguides can have certain advantages over those fabricated from solid-state optical waveguides. In some cases, it can be easy to fabricate low-loss optical waveguides that split smoothly (e.g., θₛₚₗᵢₜ<0.5°), eliminating sharp discontinuities in the index of refraction typical of solid-state splitters. Sometimes, solid-state devices require the use of high resolution lithographic tools to generate waveguides that split with a small angle and require substantial effort and expense to generate angles <2° between the two cores that have optically smooth edges (e.g., edge roughness <500 nm).

In the embodiments illustrated in FIGS. 12B and 12C, each end of channel 14 can taper from a large width (i.e., region 214A, 150 μm wide, as shown in FIG. 12B, and region 214C, 500 μm wide, as shown in FIG. 12C, and) to a central region 214B having a small width (e.g., 50 μm). In some cases, wide region 214C, i.e., near the fluid inputs, can simplify the characterization of the light exiting the fluid/fluid waveguide by expanding the separation between the liquid cores. In some cases, the wide region 214A, i.e., near the fluid outputs, can improve the coupling efficiency of light from the optical fiber into the fluid/fluid waveguide. In one embodiment, the narrow region in the center of the channel network (region 214B) can decrease the transverse length over which the core and cladding fluids mix (i.e., the width of the central cladding stream) to a small distance, such as a distance of less than 50 μm, less than 30 μm, less than 10 μm, less than 5 μm, or less than 1 μm. It is to be understood that the structural arrangement illustrated in the figures and described herein is but one example, and that other structural arrangements can be selected. In some embodiments, the refractive index of the core and cladding streams may be directly proportional to the concentration of the components of the liquids. For instance, a gradient in the contrast of the refractive index (Δn=n_{core}−n_{cladding}) can develop as the fluids flow through the channel because of diffusion of the cladding fluid (i.e., water from the ethylene glycol:water mixture) into the core fluid and diffusion of the core fluid (i.e., ethylene glycol) into the cladding fluid. To a first approximation, this gradient can be estimated by considering only this mutual diffusion, independent of the composition of the cladding and core fluids. The diffusion coefficient for this scenario was estimated to be ˜5×10⁻⁶ cm²/s by taking a value representative of 9:1 (ethylene glycol:water) composition. This model indicates that diffusion across the width of the central cladding stream separating the two core fluids over the length (e.g., 1 cm) of this narrow region of the channel occurs more rapidly than the residence time (τ=ratio of the volume of the channel to the rate of flow) of the liquids in this region, for rates of flow <5 μL/min (τ>0.75 s in channels with dimensions of 0.005 cm×0.0125 cm×1 cm (w×h×l)). This diffusion eliminated the optical separation of the core streams in this region. In other words, an optical interface was removed between the cores streams.

An electromagnetic radiation source can be constructed and arranged to irradiate a waveguide core in the channel from a variety positions, including axially in the direction opposite of fluid flow, as described above. For instance, fluids defining one or more waveguide cores can be flowed in a first direction and electromagnetic radiation may propagate in a direction substantially opposite in the first direction. In another embodiment, an electromagnetic radiation source can be constructed and arranged to irradiate a waveguide core in the axial direction from an inlet towards an outlet (e.g., in the direction of intended fluid flow in a waveguiding region or in the direction of increasing extent of diffusive mixing). For instance, in one embodiment, fluids defining one or more waveguide cores can be flowed in a first direction and electromagnetic radiation may propagate in the one or more cores substantially in the first direction. Of course, an electromagnetic radiation source can be positioned at an angle (e.g., 30°, 70°, 90°, 120°) relative to the axial direction.

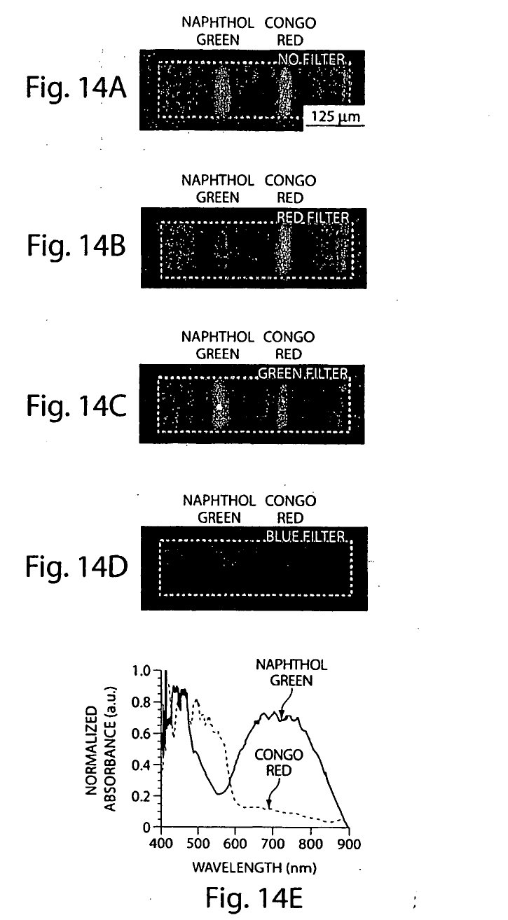

In certain embodiments, optical properties of the individual core fluids can be separately tuned using streams of fluids containing different dyes. These dye molecules can absorb light of specific wavelengths. In one embodiment, the inclusion of dyes in a waveguide system can generate a simultaneous, two-color, subtractive wavelength filter. In one particular embodiment, fluid/fluid waveguides comprising liquid cores containing dissolved dyes (e.g., congo red and naphthol green (1 mM)) can be prepared in waveguide system 200. A tungsten lamp, coupled to the fluid/fluid waveguides with a multi-mode optical fiber, can be used to provide a source of white light. FIG. 14A is an optical micrograph of the output beams from each of the dye-doped, fluid/fluid waveguides.

FIGS. 14A-14D show cross-sections of channel 214 as viewed through delivery site 224. The dashed box shows the walls of the channel. In this particular embodiment, the rate of flow of the core fluids was 5 μL/min, of the inner cladding fluids was 10 μL/min, and of the outer cladding fluids was 20 μL/min. The image in FIG. 14A was taken without a color filter. The images in FIGS. 14B-14D were taken with the color filter as listed above the images. A small amount of red light was observed in FIG. 14C when viewed through the green filter because congo red absorbs light of λ<600 nm and the green filter transmits wavelengths of λ=600-650 nm.

The absorbance spectrum shown in FIG. 14E was measured using a fiber-coupled UV-Vis spectrometer (Spectral Instruments, Inc., Tuscon, Ariz.). The absorbance spectra measured for each dye were similar to those in the published literature. Significant diffusive mixing of the dyes along the length of the channel was not observed because of the relatively low diffusion constants of the large dye molecules (e.g. compare 2×10⁻⁶ cm²/s for congo red vs. 11.7×10⁻⁶ cm²/s for ethylene glycol in water). As a result, the light contained within one core fluid could be filtered largely independently from the light contained in the second core. The liquid core of the region of the device forming a single waveguide at the light input of the filter contained both red and green dyes and in some cases, can result in some absorptive loss in both parts of the spectrum simultaneously.

Advantageously, dye molecules dissolved in a fluid core can be used to filter wavelengths of light from a white light source. Since the dyes can be continually replaced in the flowing waveguide, photobleaching can be minimized in some instances. The frequency distribution of the filtered light can also be easily selected by changing dyes. A variety of different dyes can be used in accordance with the present invention.

In some embodiments, 1×2 optical splitters can be expanded laterally to include additional fluid/fluid waveguides within the same system to create a 1×n splitter, where n>2. This capability can enable the simultaneous splitting and filtering of a single, white-light source into many independent, multicolor light sources. The absorbance properties of the fluid cores can be tuned dynamically across the spectrum of visible wavelengths if, for instance, a large number of organic dyes are soluble in a waveguide core fluid. Ethylene glycol is one example of such a fluid. The tunable optical properties of these devices may be useful for on-chip analysis where optical excitation and detection of light of specific wavelengths is necessary.

In another embodiment of the invention, an optical waveguide comprises a thermal gradient across a fluid in a channel. In some cases, the fluid in the channel is homogeneous. The thermal gradient can cause a distribution of the refractive index across the channel, which can form the core and cladding structures of an all-fluid waveguide. Advantageously, properties and functions of fluid/fluid waveguides can be reconfigured in real time, e.g., by adjusting rates of flow, composition of the fluids, and/or controlling the extent of the thermal gradient applied. In addition, since heat can be supplied radiatively (i.e., without mass transfer), thermally-based devices can use arbitrary configurations of optical interfaces.

In principle, any suitable material can be used to make thermally-defined optical structures, provided there is a large enough change in refractive index with change in temperature (dn_{D}/dT). In some embodiments, in order to establish a stable thermal gradient, it is necessary to maintain the system away from the equilibrium (i.e., uniform temperature distribution) by balanced use of heat sources and sinks.

A thermal gradient in a fluid can be formed by a variety of methods. In one embodiment, a thermal gradient is formed by providing a first fluid having a first temperature in a channel (i.e., the first fluid defining a waveguide core) and a second fluid having a second temperature in the channel (i.e., the second fluid defining a fluid cladding), wherein the first and second fluids can be compositionally identical or different. The fluids can be heated or cooled by various methods known to those of ordinary skill in the art.

In another embodiment, a fluid can be provided in a channel and a thermal gradient can be established, i.e., after the fluid has entered into the channel. The thermal gradient can be formed, for instance, by local heating elements positioned on the walls of the channel and/or by use of electrical heating elements (e.g., coils). This configuration can cause, in some cases, a portion of a fluid near the walls of the channel to be heated to a greater extent than a portion of a fluid farther away from the walls. In another embodiment, heating of the fluid in waveguide can be accomplished indirectly by heating the article (substrate) in which the channel is formed.

In one particular embodiment, the center of a fluid can be heated by heating a wire positioned in the center of the channel in which the fluid is contained.

In another embodiment, a thermal gradient can be established perpendicular to the longitudinal axis of the channel (i.e., in an axial direction). This can occur if, for example, fluid near the walls of a channel are heated (or cooled) to a greater extent than fluid near the center of the channel. In another embodiment, a thermal gradient can be established parallel to the longitudinal axis of the channel. In some cases, this configuration can be formed by heating (or cooling) at least one end of the channel to a greater extent than that of, for instance, the center of the channel. In some cases, gradients established parallel to the longitudinal axis are more easily accomplished with thermal gradients than with chemical gradients.

FIG. 15A shows an example of a waveguide that can comprising a thermal gradient according to one embodiment of the invention. In the embodiment illustrated in FIG. 15A, waveguide system 300 includes waveguiding region 305 in fluid communication with waveguide core inlets 310 and 312, cladding inlets 314 and 316, and outlets 318 and 320. An electromagnetic radiation source (e.g., a laser diode (635 nm) or a quartz halogen lamp) can be coupled into the waveguide using an optical fiber, and may be positioned to propagate light in waveguiding region 305 in the direction of arrow 332, towards output region 336. The length (z), width (x) and height (y) of waveguiding region 305 can be, for example, 5 mm, 400 μm, and 125 μm respectively. It is to be understood that the structural arrangement illustrated in this figure and described herein is but one example, and that other structural arrangements can be selected. For instance, in some embodiments, additional core and/or cladding inlets can be provided, i.e., for forming multiple waveguide cores. In another embodiment, fewer core and/or cladding inlets can be provided (e.g., a waveguide system may comprise one core inlet and two cladding inlets). In another embodiment, an electromagnetic radiation source can positioned so that light propagates in a direction substantially opposite of arrow 332.

In one embodiment, guiding electromagnetic radiation can be achieved by constructing a device with a central cold stream bound by two adjacent hot streams in a single channel. For instance, in system 300 of FIG. 15A, first, cold streams (e.g., fluids at 21° C. or room temperature) can be introduced into system 300 via inlets 310 and 312, and second, hot streams can be introduced via inlets 314 and 316. In one particular embodiment, the fluid claddings can be preheated (e.g., within a hot water bath) and injected at temperatures, i.e., ranging from 30° C. to 75° C. In addition to the initial temperature difference between the hot and cold streams, the flow rate of the fluids can be controlled. Flow rate can change the extent of lateral heat diffusion across the channel and, therefore, the refractive index contrast (Δn=n_{core}−n_{cladding}).

FIG. 15B shows that temperature and refractive index of a fluid are inversely related. The average slopes (dn_{D}/dT) for each solution were 1.2×10⁻⁴ (water), 4.0×10⁻⁴ (ethanol), 2.6×10⁻⁴ (ethylene glycol), and 3.4×10⁻⁴ (perfluoro(methyldecalin)). The trend in these values is consistent with what is expected from reported thermal expansion coefficients (α): 2.0×10⁻⁴° C.⁻¹ (water), 11×10⁻⁴° C.⁻¹ (ethanol), and 6.5×10⁻⁴° C.⁻¹ (ethylene glycol), i.e., thermal sensitivity of index of refraction increases with α.

FIG. 15B can aid in determining which fluids and/or temperatures can be used as core and/or cladding fluids. In order to determine the conditions required for optical waveguiding with thermal gradients, the output of the such a waveguide can be measured at various input temperatures and flow rates. In one embodiment, all of the fluids in FIG. 15B provided adequate dn_{D}/dT to observe waveguiding.

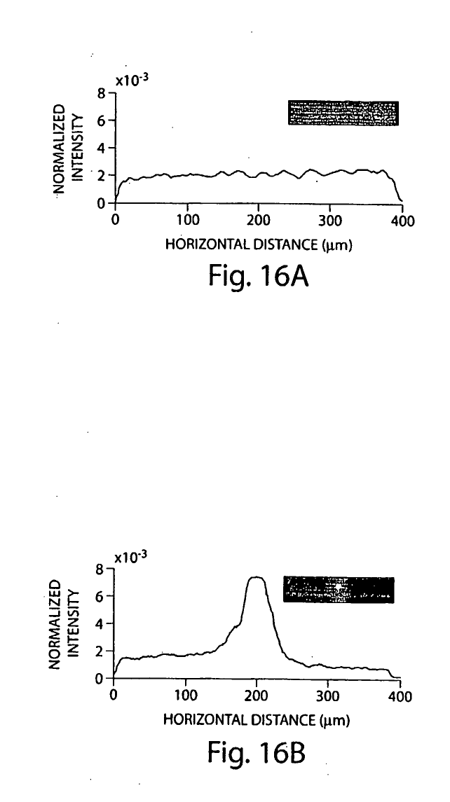

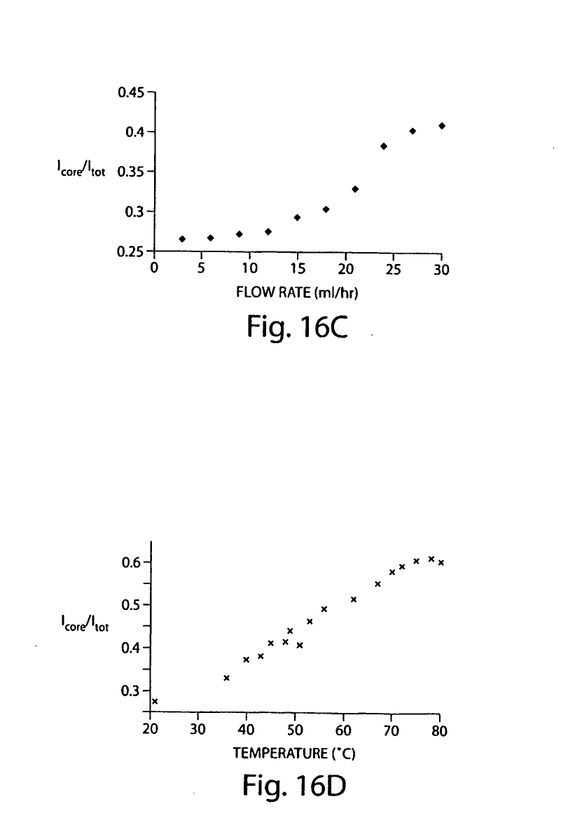

In one embodiment, the performance of the waveguide can be evaluated by examining the intensity profiles across waveguiding region 305 at waveguide output region 336. FIGS. 16A and 16B show plots of average intensity from left to right (I/Iₜₒₜ) across waveguiding region 305 at two different total flow rates (3 ml h⁻¹ and 30 ml h⁻¹ respectively). In this particular embodiment, the flow rates of the core streams and cladding streams were maintained at a ratio of 1:2; the cladding streams were at a temperature of 72° C. and the core was at a temperature of 21° C. at their respective inlets. The inset images of FIGS. 16A and 16B show optical micrographs for the waveguide light output. The image in FIG. 16A depicts the light output where the rate of flow does not meet the requirement for waveguiding. The image in FIG. 16B shows the output when the flow rate is sufficient to maintain the thermal gradient for the whole length of the channel to meet the requirement for waveguiding.

FIG. 16C is a plot showing the ratio of the intensity of the core to the total intensity of the channel as a function of total flow rate, according to one embodiment of the invention. As shown in this figure, a higher total flow rate reduced lateral thermal diffusion, resulting in a steeper temperature gradient and higher contrast in refractive indices across the width of the waveguiding region. Thus, more light was confined in the core region of the waveguide at these steeper temperatures.

FIG. 16D shows a plot of intensity ratio (I_{core}/Iₜₒₜₐₗ) as a function of inlet temperature at constant total rate of flow (30 ml hr⁻¹). Water flowing into the core was at a temperature of 21° C., while the water in the cladding varied from 21° C. to 80° C. In one embodiment, a larger temperature difference between the liquids in the core and cladding regions resulted in a steeper thermal gradient and a greater contrast in refractive index across the width of the channel (higher numerical aperture of the guide, NA∝Δn), and hence a higher intensity ratio in the core region. The results we obtained for other liquids were similar to those for water. Compared to water, the minimum temperature and rates of flow required for waveguiding were highest for water, followed by ethylene glycol, ethanol and perfluoro(methyldecalin).

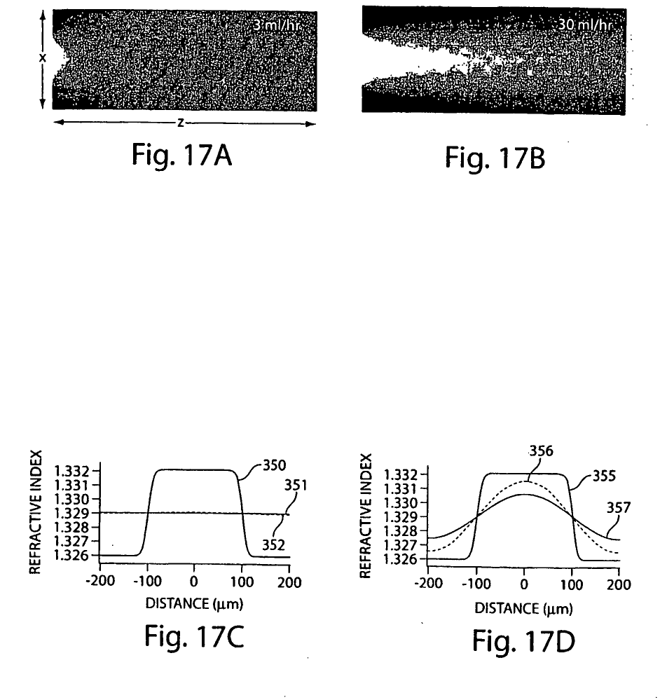

FIGS. 17A and 177B show the calculated profiles of refractive index distribution due to thermal diffusion for water along the longitudinal axis (z-direction) of waveguide region 305. The waveguide region was 0.5 cm-long and formed by water at flow rate of 3 ml/hr (FIG. 17A) and 30 ml/hr (FIG. 17B), and with temperatures of T_{core}=21° C. and T_{cladding}=71° C. Lines 350 and 355 correspond to measurements at the beginning of the channel (i.e., near the fluid inlets); lines 351 and 356 correspond to measurements near the middle of the channel; and lines 352 and 357 correspond to measurements near the end of the channel.

The temperature was calculated according to the heat conduction equation:

$$\frac{\partial T ( r , t )}{\partial t} = κ {∇}^{2} T ( r , t )$$

where κ is the thermal diffusivity and has units of m² s⁻¹.

$$κ = \frac{k}{ρ ε p}$$

and ρ is the density, Cp is the specific heat, k is the thermal conductivity. As the thermal diffusivity of water (˜1.5×10⁻⁷ m² s⁻¹) is higher than its mass diffusivity (˜2.7×10⁻⁵ m² s⁻¹) by two orders of magnitude in the temperature range of interest (21° C.-80° C.), diffusive broadening of the interface between the core into the cladding occurred in a shorter distance (or at a shorter residence time in the channel) compared to waveguides composed of two liquids with different composition. This broadening limited the maximum transit time and length of this waveguide to about 0.03 s and 1.2 cm for a flow velocity of 0.4 m/s in 400-μm-wide channels.

In one embodiment, the rapid dissipation of heat in fluid systems can lead to rapid switching times when reconfiguring thermal optical structures (i.e., compared to systems that rely on mass diffusion). In another embodiment, thermal waveguide systems can be compatible with any single fluid providing sufficient thermal expansion. In some cases, reconfiguring the properties of the waveguide is simple through changes in flow rate and temperature. For instance, by changing the total flow rate of the fluid into the microfluidic channel and the temperature difference between the core and cladding regions, the contrast in refractive indices across the waveguide can be fine-tuned. In certain cases, this principle can be applicable for other optical structures such as Gradient Index (GRIN) lenses and to systems operating with in-line radiative heating elements.

In another embodiment, a recycling system and method of reusing at least a portion of a waveguide core fluid and/or cladding fluid is provided. For instance, a method may include flowing a waveguide core fluid from an upstream location toward a downstream-location within a channel, flowing a cladding fluid (i.e., adjacent to the first fluid) from the upstream location toward the downstream location within the channel, and establishing an internally-reflective electromagnetic radiation pathway within the waveguide core. While maintaining an internally-reflective electromagnetic radiation pathway within the waveguide core, at least a portion of the waveguide core fluid and/or cladding fluid can be passed from the downstream location of the channel toward the upstream location of the channel. For instance, the waveguide core fluid and/or the cladding fluid can be re-introduced into the channel from the downstream position, and flow again from the upstream location toward the downstream location within the channel.

In one embodiment, the recycling system includes a waveguide core fluid and a cladding fluid which are the same (i.e., have substantially identical chemical compositions). These fluids may have, for instance, different temperatures which can cause a change in refractive index between the fluids. Once the fluids enter an outlet, they can be collected (i.e., in a common reservoir). In some cases, if the core and cladding fluids are chemically homogeneous, they do not need be separated downstream; such systems can be operated in closed loops. From a common reservoir, the fluids can be separated into different channels streams, and re-introduced into the waveguide core and cladding inlets. In some embodiments, it may be desirable to heat the fluids to certain temperatures before the fluids enter into the waveguide channel. Heating can take place, e.g., locally on the device, by various methods of heating known in the art.

In another embodiment, the waveguide core fluid and the cladding fluid are different (i.e., have substantially different chemical compositions). In some instances, the different fluids are immiscible. Thus, the fluids can flow out of an outlet, be collected (e.g., in a common reservoir), and the fluids can separate, i.e., based on their different densities, before being re-introduced into the waveguide core and cladding inlets.

Different types of fluids can be used as waveguide core and cladding fluids in a fluid/fluid waveguide of the present invention. Fluids can be chosen based on, for example, their miscibility, density, refractive indices, i.e., relative to each other and/or relative to the channel in which the fluids are contained in, tendency to not swell or dissolve the channel that they are contained in, and/or ability to solvate certain compounds, e.g., organic dyes.

In some cases, a sample fluid (i.e., a fluid containing a component to be tested) can define a waveguide core fluid. For example, in one embodiment, a biological fluid such as a solution of blood (or plasma), i.e., having a higher refractive index than a saline solution, pure water, or salt solution, can be used as a waveguide core fluid. Additionally, a saline, water, or salt solution, i.e., having a relatively lower refractive index than blood, can be used as a cladding fluid in the waveguide system. In one particular embodiment, a solution of blood can be diluted and the flow rate controlled such that only a single cell flows in the waveguide core at a point in time. Having a fluid cladding solves the problem of channel-wall contamination with the biological analytes (e.g., proteins, blood components) via doing away with contact between analyte fluid and the walls of the channel. Guiding electromagnetic radiation in the waveguide core can allow spectroscopic analysis of a component (e.g., the cell) within the sample. In one particular embodiment, a broad band or laser light source is coupled to and from the fluid/fluid waveguide analysis chamber by solid fibers connected to such an external light source and a spectrometer or detector input.

While several embodiments of the invention have been described and illustrated herein, those of ordinary skill in the art will readily envision a variety of other means and structures for performing the functions and/or obtaining the results or advantages described herein, and each of such variations or modifications is deemed to be within the scope of the present invention. More generally, those skilled in the art would readily appreciate that all parameters, dimensions, materials, and configurations described herein are meant to be exemplary and that actual parameters, dimensions, materials, and configurations will depend upon specific applications for which the teachings of the present invention are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described. The present invention is directed to each individual feature, system, material and/or method described herein. In addition, any combination of two or more such features, systems, materials and/or methods, if such features, systems, materials and/or methods are not mutually inconsistent, is included within the scope of the present invention.

In the claims (as well as in the specification above), all transitional phrases such as “comprising”, “including”, “carrying”, “having”, “containing”, “involving”, “composed of”, “made of”, “formed of” and the like are to be understood to be open-ended, i.e. to mean including but not limited to. Only the transitional phrases “consisting of” and “consisting essentially of” shall be closed-or semi-closed transitional phrases, respectively, as set forth in the United States Patent Office Manual of Patent Examining Procedures, section 2111.03.

What is claimed is:

1. A method for guiding electromagnetic radiation in a waveguide, comprising:
guiding electromagnetic radiation in a first waveguide core comprising a fluid, the waveguide core being adjacent a fluid cladding, wherein the waveguide core and the fluid cladding are formed in a microfluidic channel; and
delivering electromagnetic radiation from the core.

2-3. (canceled)

4. A method as in claim 1, further comprising introducing electromagnetic radiation into the waveguide core.

5. A method as in claim 1, further comprising generating electromagnetic radiation in the waveguide.

6. A method as in claim 1, wherein the chemical, biochemical, or biological reaction or species is on a chip.

7. A method as in claim 1, further comprising delivering electromagnetic radiation from the core to a device constructed and arranged to decode a time-varying signal carried by the electromagnetic radiation.

8. A method as in claim 1, further comprising delivering electromagnetic radiation from the core in a direction of the electromagnetic radiation pathway.

9. A method as in claim 1, further comprising delivering electromagnetic radiation from the core in an axial direction.

10. A method as in claim 1, further comprising changing the physical orientation of core relative to the cladding.

11. A method as in claim 10, wherein changing the physical orientation of the core comprises changing one of the size and shape of the core.

12. A method as in claim 1, further comprising changing the composition of the core.

13. (canceled)

14. A method according to claim 1, wherein the core and the cladding are supported by a flexible microfluidic channel.

15. A method as in claim 14, wherein at least a portion of the flexible microfluidic channel comprises PDMS.

16-19. (canceled)

20. A method as in claim 1, comprising changing the physical orientation of the core relative to the cladding, thereby changing the waveguide core from a single-mode core to a multi-mode core.

21-22. (canceled)

23. An apparatus comprising:
a microfluidic channel for supporting a fluid waveguide core and an adjacent cladding, the channel having an axial direction;
a core fluid inlet for receiving a fluid that forms the core;
a cladding fluid inlet for receiving a fluid that forms the cladding; and
an electromagnetic radiation source constructed and arranged to irradiate the core.

24. An apparatus as in claim 23, further comprising a liquid pump to pump liquid into the core fluid inlet.

25. An apparatus as in claim 23, wherein the microfluidic channel is formed in a channel substrate comprising an elastomeric material.

26-38. (canceled)

39. A method as in claim 1, further comprising:
forming at least second and third fluid waveguide cores adjacent the fluid cladding, the first, second, and third cores able to guide electromagnetic radiation and the second and third cores joining the first core at a splitting junction; and
guiding electromagnetic radiation within each of the first, second, and third cores.

40-88. (canceled)

89. A method as in claim 1, wherein the first waveguide core is defined by
a first fluid having a first temperature and the fluid cladding is defined by
a second fluid having a second temperature, wherein the first and second fluids can be compositionally identical or different, and wherein the first and second temperatures are different; and
guiding electromagnetic radiation in the waveguide core.

90-106. (canceled)

107. A method as in claim 1, comprising delivering electromagnetic radiation from the core to affect or analyze a chemical, biochemical, or biological reaction that is outside the core, or to affect or analyze a chemical, biochemical, or biological species that is outside the core.

108. An apparatus as in claim 1, wherein the electromagnetic radiation source is constructed and arranged to irradiate the core from a non-axial direction.
